(19) United States
(12) Patent Application Publication
(10) Pub. No.: US 2006/0210757 A1
(43) Pub. Date: Sep. 21, 2006

(54) Writable optical record carrier

(75) Inventors: Andrei Mijiritskii, Eindhoven (NL); Erwin Rinaldo Meinders, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/539,361

(22) PCT Filed: Nov. 20, 2003
(86) PCT No.: PCT/IB03/05370

§ 371 Date: Jun. 15, 2005

(30) Foreign Application Priority Data
Dec. 19, 2002 (EP) 02080393.8

(51) Int. Cl. B32B 3/02

(52) U.S. Cl. 428/64.4

(57) ABSTRACT

The present invention relates to a writable optical record carrier and a method of writing information on such a writable optical record carrier. The record carrier comprises a substrate carrying a recording stack which recording stack comprises, in this order, a recording layer and an absorption layer. The recording layer is essentially transparent for an incident light beam, and comprises material which changes its optical characteristics when heated. The first absorption layer converts the incident beam to heat thereby indirectly changing the optical characteristics of the recording layer material. The method comprises the steps: positioning a writing unit at a predetermined position, generating the beam by means of the writing unit, at least partially absorbing the beam in the first absorption layer, thereby producing a first spot of heat, conducting the heat towards the recording layer, and thereby locally changing the optical characteristics of the recording layer material.

The present invention relates to a writable optical record carrier comprising a substrate carrying a recording stack. It further relates to a method for writing information on such a writable optical record carrier using a beam of electromagnetic radiation at a predetermined wavelength, preferably at a wavelength in the range from 230 nm to 800 nm.

Writable optical record carriers have seen an evolutionary increase in data capacity by increasing the numerical aperture of the objective lens and a reduction of the laser wavelength. The total data capacity was increased from 650 MB (CD, NA=0.45, λ=780 nm) to 4.7 GB (DVD, NA=0.65, λ=670 nm) to finally 25 GB (Blu-ray disk (BD), NA=0.85, λ=405 nm). Whereby, two different writing principals are applied: dye recording in case of write once CD-R and DVD+R and phase-change recording in case of rewritable CD-RW, DVD-RAM, DVD-RW, DVD+RW, and BD-RE.

Phase-change recording media commonly comprise a phase-change material as recording layer sandwiched in a stack between two dielectric ZnS—SiO₂ layers. The phase-change material typically is an alloy with a durable polycrystalline structure, e.g. an alloy composed of Ge, Sb, and Te or In, Ag, Sb, and Te. On one side of such a recording stack a mirror layer is deposited which is typically made of metal such as gold or aluminum or silver. The recording stack is deposited on a substrate such as a polycarbonate substrate. A writing laser beam modulated by a recording signal entering the recording medium from the substrate side will principally be absorbed by the recording layer, whereas the part of the laser light absorbed by the mirror layer amounts to much less than 5% to 10%. Thereby, the metallic alloy is locally heated. When the temperature exceeds about 500° C. to 700° C. the alloy's phase changes into an amorphous state. A rapid heat transport through the adjacent dielectric layers causes a fast cooling of the alloy, thereby stabilising the amorphous phase. Thus written marks remain. Applying a laser beam with a reduced power allows to erase written marks. Thereby, the recording layer is heated to a temperature of about 200° C. inducing a phase change back to the crystalline phase. Whereas the crystalline phase (ground state) has a high reflectivity the amorphous phase (written state) has a reduced reflectivity. Therefore a reading beam focused on said recording stack is reflected by the recording layer with different intensity depending on whether it strikes a written mark (pit) or an unwritten area (land).

Dye recording type discs are typically composed of a polycarbonate substrate having an organic dye layer applied as recording layer on a first surface. Known dye materials are cyanine, phthalocyanine and metallized azo. A reflective metal layer, typically a gold or silver layer, is attached to a second surface of said recording layer opposite to the substrate. A writing laser beam entering the stack from the substrate side will be partially absorbed by the recording layer, which is heated in that way. Thereby, the dye pigments durably and irreversibly change their color and structure, i.e. the recording layer is locally bleached and decomposed. Also, some mechanical deformation of the recording stack may occur. A reading beam striking a mark written in that manner will be partially scattered by the bleached area. Consequently, the intensity of the light reflected at said reflective metal layer depends on whether the reading beam strikes a mark or passes the recording layer almost undisturbed.

The growing demand for dyes that are optimized for recording at a certain wavelength, the race of higher recording speed, the general demand for higher data capacity and lower cost has motivated manufacturers to seek after new recording materials. At the same time materials that have already been developed for a certain recording system (such as e.g. CD-R) are not considered to be employed for other systems (e.g. DVD) because of their optical properties at those wavelengths. For instance, these materials are considered to be not usable for recording information at the demanded wavelength since the light will not be sufficiently absorbed by them in the initial (unrecorded) state.

Therefore, it is an objective of the present invention to provide a writable optical record carrier and a method of writing information on such a writable optical record carrier comprising a recording layer which is essentially transparent in the unrecorded state for the incident beam of electromagnetic radiation at a predetermined wavelength.

According to the present invention this objective is achieved by a writable optical record carrier comprising a substrate carrying a recording stack which recording stack comprises, in this order, a recording layer and formed on said recording layer opposite the substrate a first absorption layer. The recording layer is essentially transparent in its initial (unrecorded) state for an incident beam of electromagnetic radiation at a predetermined wavelength, and comprises material which changes its optical characteristics when it is heated. The first absorption layer comprises material which has an absorption coefficient being sufficiently high at the predetermined wavelength to convert the incident beam to heat and thereby changing the optical characteristics of said recording layer material. Preferably the recording layer comprises organic dye material being essential transparent in the initial, unrecorded state and the absorption layer is a dielectric. According to a further preferred embodiment of the invention the record carrier comprises a second absorption layer located on the opposite side of said first absorption layer adjacent to said recording layer, thus sandwiched between the recording layer and the substrate. Also, a cover layer may be used through which the laser beam is focused.

According to claim 12 of the present invention the objective is further achieved by a method for writing information on such a writable optical record carrier in which marks representing the information are written via a beam of electromagnetic radiation at a predetermined wavelength. The method according to the invention comprises the following steps

positioning a writing unit at a predetermined position with respect to said record carrier,

generating said beam with a predetermined writing power by means of the writing unit,

at least partially absorbing said beam in the first absorption layer, thereby producing a first spot of heat,

conducting the heat produced in the first absorption layer towards the recording layer, and

locally changing the optical characteristics of said recording layer material by means of the heat conducted from the heat spot in the first absorption layer.

Further preferred embodiments of the method for writing on such a writable optical record carrier are defined in the dependent claims 11, and 12.

Whereas, all known recording methods and rewritable or write-once record carriers such as CD-R, CD-RW, DVD+R, DVD-RAM, DVD-RW, DVD+RW, and BD make use of directly heating the recording layer, the present invention provides an indirect heating recording principal. Therefore, the present invention allows to employ materials for recording information which are essentially transparent for the beam of electromagnetic radiation at the predetermined wavelength. This provides an opportunity to apply well standardized optical recording methods such as CD-R, CD-RW, DVD+R, DVD-RAM, DVD-RW, DVD+RW recording, for example, employing materials so far having been considered unusable for this purpose due to their low absorption coefficient at the wavelength predetermined by said standards.

The above an other objectives, features and advantages of the present invention win become apparent from the following description of preferred embodiments thereof taken in conjunction with the accompanying drawings in which

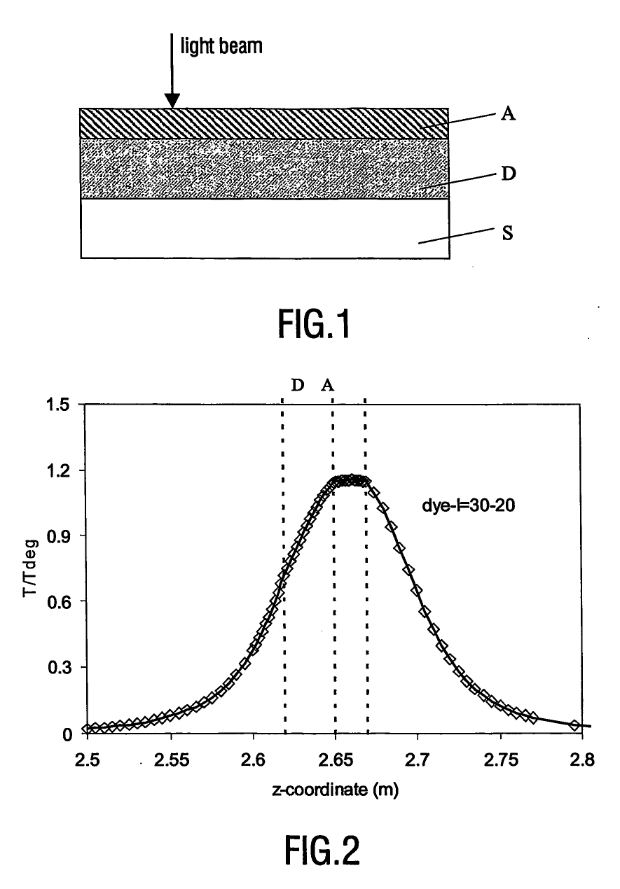

FIG. 1 illustrates a cross-section view of a writable optical record carrier according to a first embodiment of the invention;

FIG. 2 shows the temperature distribution in the depth direction of the record carrier according to FIG. 1;

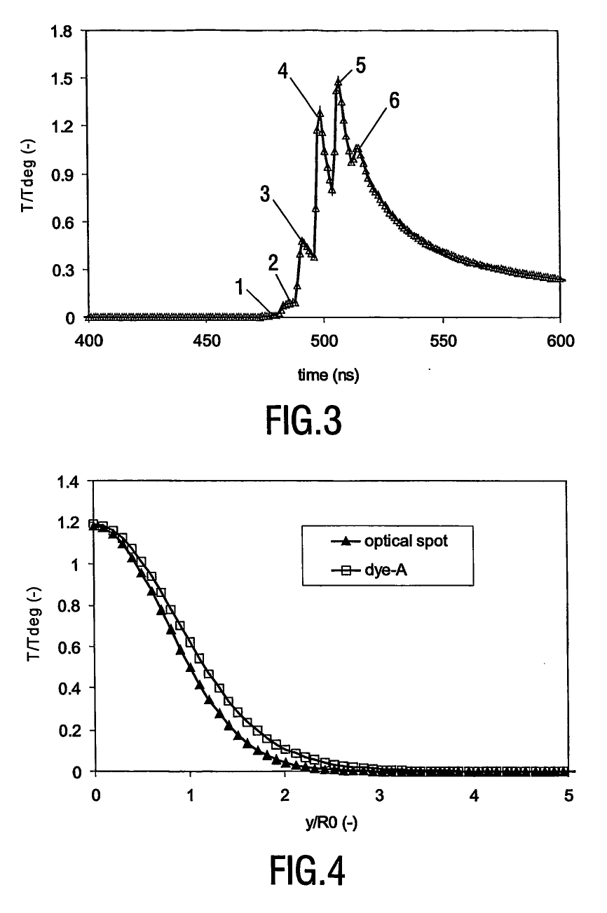

FIG. 3 shows a temperature response of the record carrier according to FIG. 1 to a write strategy consisting of six short write pulses;

FIG. 4 shows a radial temperature response of the record carrier according to FIG. 1;

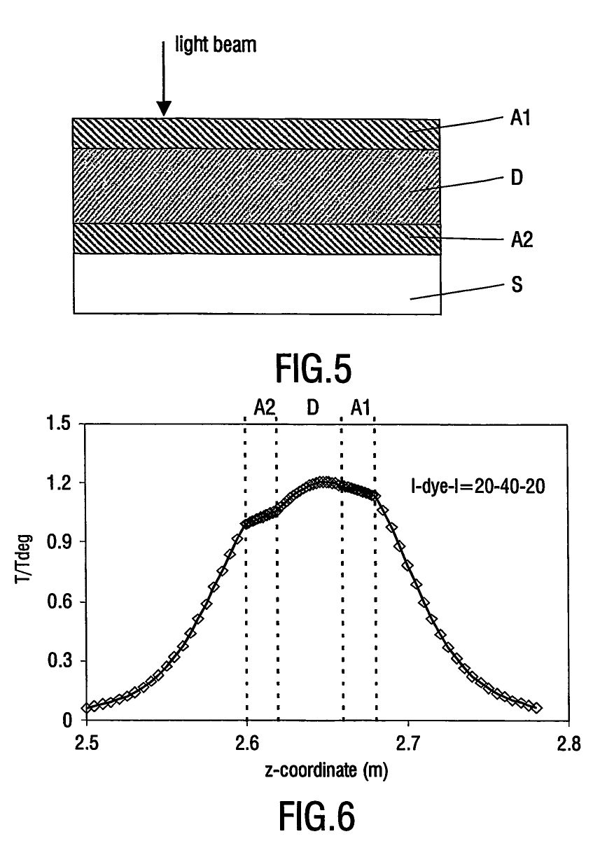

FIG. 5 illustrates a cross-section view of a writable optical record carrier according to a second embodiment of the present invention;

FIG. 6 shows the temperature distribution in the depth direction of a record carrier according to the second embodiment of the present invention in FIG. 5;

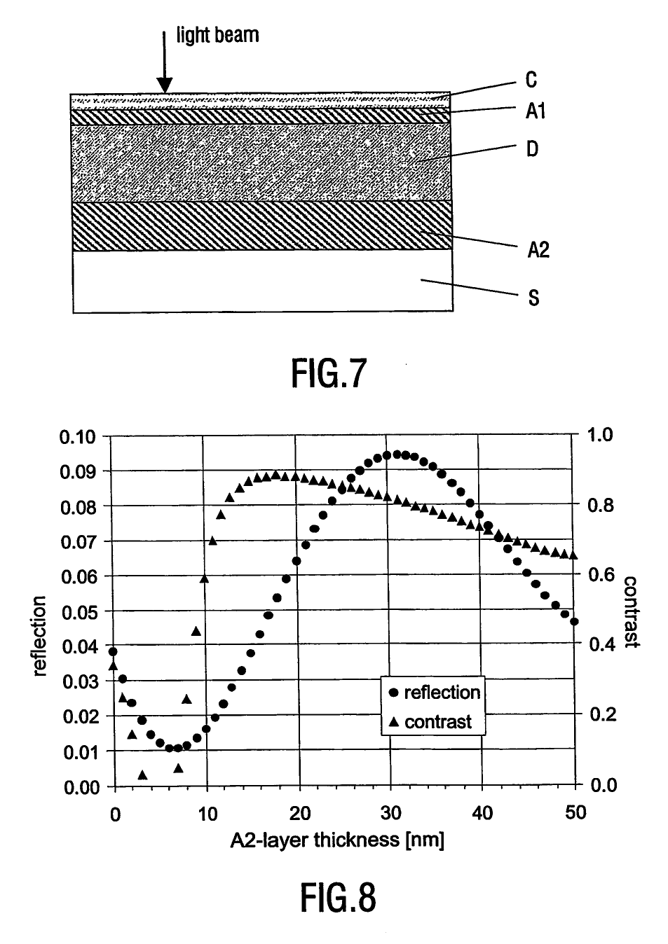

FIG. 7 illustrates a cross-section view of a writable optical record carrier according to a third embodiment of the present invention;

FIG. 8 shows the optical performance of a record carrier according to FIG. 7;

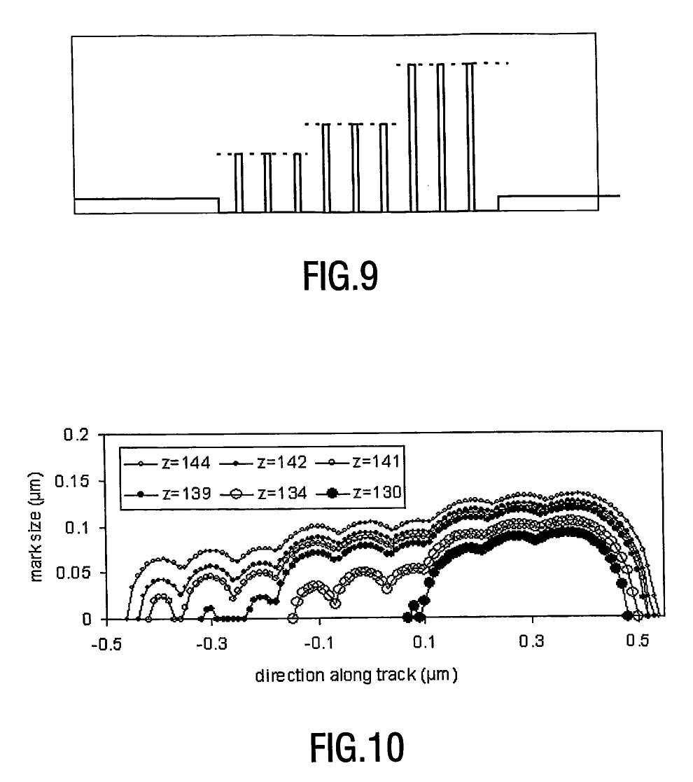

FIG. 9 illustrates a multi-pulse write strategy with nine write pulses and three embedded modulation levels;

FIG. 10 shows a depth profile of the calculated mark shape corresponding to the write strategy shown in FIG. 9.

According to a first preferred embodiment of the present invention a recording stack for a writable optical record carrier with the most simple stack design as shown in FIG. 1, a so-called DA stack, consists of an organic dye layer D which is attached as recording layer to a first absorbing layer A made of dielectric ZnS—SiO₂. The choice of the dielectric layer depends on the absorption in the designated wavelength range. According to this embodiment an incident beam of electromagnetic radiation is chosen at λ=266 nm. As can be seen from table 1 ZnS—SiO₂ comprises a relatively high absorption coefficient at this wavelength. Thus, this material acts as an absorber for the electromagnetic radiation. The degradation temperature of the organic dye material, that is the temperature at which decomposition of the dye starts, is about 300° C. The absorption layer according to this embodiment is 20 nm thick. The recording layer has a thickness of 30 nm.

According to this embodiment the recording stack is deposited with its recording layer side onto a substrate S, e.g. made of a polycarbonate, polymethyl metacrylate, amorphous polyolefin or glass. The recording layer may have a thickness in range of 1 nm to 200 nm and the first absorption layer may have a thickness in the range of 1 nm to 500 nm. The record carrier may be of the air-incidence type or may further have a protective cover layer attached to the absorption layer, not shown in FIG. 1. This cover layer may be made of e.g. Sylgard 184 (see table 1). In case of BD-disc, for example, this layer may be about 100 μm thick. The embodiment according to FIG. 1 represents a write-once recording stack.

An TV laser beam, as indicated in FIG. 1 by an arrow, is generated by a writing unit positioned at a predetermined position with respect to the record carrier. It enters the stack from the side of the absorption layer and is focused by said writing unit on the stack. In case a cover layer is present the light is focused through that cover layer. Then, the energy transported by the electromagnetic radiation is partially absorbed in the dielectric ZnS—SiO₂ layer. In other words, the electromagnetic energy is converted to a first spot of heat within the first absorption layer. Whereas the adjacent organic dye layer is essentially transparent at UV wavelength (see table 1) and therefore the absorption of this layer itself is too small to induce sufficient heat for changing its optical properties, the heat spreading from the absorption layer towards the organic dye layer via heat conduction at sufficiently high laser powers induces a temperature rise in the organic dye layer that exceeds the dye bleaching/decomposition temperature. In this way, via indirect heating marks are written in the recording layer material being essentially transparent in one of its functional states, i.e. having a small absorption coefficient in the unrecorded states and a higher absorption coefficient in recorded state (see table 1).

TABLE 1

| Material | λ | N | k |
|---|---|---|---|
| ZnS—SiO₂ | 266 | 2.655 | 0.527 |
| Polycarbonate, substrate | 266 | 1.768 | 0.107 |
| Sylgard 184, cover layer | 266 | 1.51 | 0.00 |
| Dye, initial state | 266 | 1.83 | 0.03 |
| Dye, bleached/decomposed | 266 | 1.93 | 0.51 |
| state | | | |

Referring to FIG. 2, the temperature distribution T/T_{deg}, in a record carrier stack according to FIG. 1 is shown along the z-direction, wherein, T_{deg} represents the degradation temperature of the recording dye. The direction of increasing z-values is perpendicular to the stack extension and opposite to the direction of the incident beam entering the stack from the absorber side A, as illustrated in FIG. 1. The organic polycarbonate substrate S has a low thermal conductivity. It is attached to the organic dye layer D which in this particular example is 30 nm thick. The dye layer in the unrecorded initial state and the substrate have almost the same optical properties.

In response to an incident UV-laser beam with a wavelength of 266 nm the temperature reaches its maximum in a plateau extending across the absorption layer A and decreases to both sides of the absorption layer due to heat leakage out of the absorption layer. Thus the dye layer according to the invention is indirectly heated from laser light being absorbed in the ZnS—SiO₂ dielectric absorption layer. Due to the thermal (and optical) properties of the dye layer and the substrate, in particular, to similar small absorption coefficient and similar thermal resistance the temperature drop to both sides of the absorption layer is almost symmetric. It is noted that this result is not a generic result but is more attributed to the proposed embodiment.

A pulse write strategy was used with write pulses of 2 ns and cooling gaps between each pair of said write pulses lasting 4 ns. The recording speed of these pulses along the track was 10 m/sec. The temperature-time response of the stack according to the first embodiment of the present invention to six write pulses with a pre-heat and a post-heat level, i.e. moderate power levels prior and after the pulse train, is illustrated in FIG. 3. Each of which write pulse is indicated by number. According to this, the stack possesses a slow cooling response. The temperature decrease is so slow that the temperature adds up from write pulse to write pulse until a maximum of about 1.5×T_{deg} is reached after five pulses. When the normalized temperature T/T_{deg} reaches a value greater than 1 the temperature of the stack exceeds the degradation (or decomposition) temperature of the dye material.

Due to the slow cooling response the writable optical record carrier according to the first embodiment of the present invention is most suitable for a WORM (write once read many) optical disk. Thereby, the slow cooling behavior is not hampering the data storage other than in the case of re-writable phase-change recording media such as CD-RW, DVD-RW for example.

The absorption in the dielectric layer results in a somewhat broader temperature distribution than expected on basis of optical scaling rules as can be seen in FIG. 4. Therein, the full triangle symbol indicates the spot size of a laser beam focused on the stack according to FIG. 1. The open square symbol indicates the temperature distribution in the dielectric absorption layer in radial direction starting from the centre of the laser beam at y/R0=0. However, when using a maximum temperature of about 1.2× to 1.5×T_{deg}, i.e. about 350° C. to 500° C., while writing in a central track the temperature in the adjacent track starting at y/R0=1 and extending at y/R0=2 will not exceed T_{deg}. Since bleaching of the dye material sets of more or less abruptly when reaching T_{deg} dye-recording practically is a threshold phenomenon. Therefore, no cross write deterioration as known from phase-change materials will occur. In other words, severe degradation of adjacent tracks will not occur while the laser beam is writing in the central track.

Thus, whereas an absorption layer as commonly known from phase-change recording media causes relatively large heat spreading due to its high thermal conductivity, the thermal properties of the recording organic dye layer and the absorbing dielectric layer according to the present invention are much smaller so that the first spot of heat (heat source in the stack) in the first absorption layer is very narrow. Therefore, the heat source is very well localized so that very small marks can be written in the organic dye recording layer.

According to a second preferred embodiment of the invention, a writable optical record carrier comprises a substrate carrying a recording stack according to FIG. 5. The recording stack comprises a recording dye layer D and formed on said recording dye layer D a first absorption layer A1. Opposite to the first absorption layer A1 attached to a second surface of the recording layer D, that is between said recording layer and said substrate, there is a second absorption layer A2. Thus, a so called ADA recording stack is obtained. This second absorption layer may have a thickness in the range of in to 100 nm. According to this particular example the thickness of both dielectric absorption layers A1 and A2, however, amounts to 20 nm and the D layer is 40 nm thick so that the ADA stack is symmetrical. An UV-light beam enters the stack from the A1-side as indicated in FIG. 5. Optionally, a cover layer may be present on top of the ADA stack for protection purposes, preferably made of Sylgard 184 (table 1).

Again, the UV-laser beam having a wavelength of 266 nm is applied at a recording speed of 10 m/sec with a write pulse strategy showing six write pulses each 2 ns long and a cooling gap of 4 ns between each pair of write pulses. Then, a temperature distribution according to FIG. 6 results. The largest amount of the incident light beam is absorbed by the first dielectric absorption layer A1 corresponding to the right interval at higher z-values in FIG. 6. In that way a first spot of heat (first heat source in the stack) is produced therein. The remaining light then passes the dye layer which is essentially transparent in its initial (unrecorded) state. The beam is finally partially absorbed by the second dielectric absorption layer A2 (lower z-values), thereby, producing a second spot of heat (second heat source in the stack) therein. From both heat sources the heat is conducted towards the recording dye layer (D). Consequently, the temperature within the recording dye layer adds up, thereby partially exceeding the value obtained in each absorption layers. Furthermore, a rather steep temperature gradient within the dye layer as known from the simple DA stack mentioned with regard to FIG. 2 does not occur. For this reason, the temperature distribution across the recording-dye layer sandwiched between the two absorption layers A1 and A2 is more homogeneous and, consequently, bleaching/decomposition of the dye material will more homogeneously occur all across the recording layer.

Another preferred embodiment of the present invention is illustrated in FIG. 7. The record carrier shown therein comprises a ADA stack disposed onto a substrate S. The ADA stack comprises a first dielectric absorption layer A1, a second dielectric absorption layer A2, and sandwiched between both absorption layers a recording dye layer D. The ADA stack is not symmetrical, in particular, the first absorption A1 layer measures 4 nm, the recording layer D 40 nm, and the second absorption layer A2 28 nm in thickness. The ADA stack is disposed with its A2 side on said substrate. A cover layer C is disposed onto the A1 side of the ADA stack opposite to the substrate S.

The optical properties of the record carrier according to the preferred embodiment illustrated in FIG. 7 are shown in FIG. 8. A reading UV laser beam with a wavelength of 266 nm entering the stack from the cover layer side C as indicated in FIG. 7 is reflected at the stack due to an index of refraction mismatch. The intensity of the light reflected at an unrecorded initial state area (land) in percent of the incident beam is indicated by full circles. Triangles indicate the optical contrast of the record carrier in percent, whereby, the optical contrast represents the attenuation of the reflected light when the incident beam strikes a written or bleached final state area (pit) of the dye layer. As can be seen from FIG. 8 the intensity of the light reflected at an initial state area as well as the optical contrast depends on the thickness of the A2 layer. At the optimum value of 28 nm thickness the initial state reflection intensity amounts to 9.2% of the incident beam and the optical contrast amounts to 83.5%. Hence, a difference between the intensity of the light reflected at an initial state area and that reflected at a final state area of 7.7% results.

The AD or ADA recording stack designs according to preferred embodiments can further be extended with additional (multi-) layer structures to enhance the optical and thermal properties of the record carrier such as reflectivity for example. E.g. an I-A-D-A-I stack can be obtained, wherein, D denotes the recording dye layer, A the absorption layers and I additional dielectric, metallic, or absorption layers.

Further embodiments of the present invention provide single sided, double layer type record carriers which can be read from one side only as known from DVD and BD technology employing the indirect heating recording stacks. Thereby, preferably a semitransparent AD/ADA stack or other recording stack according to present invention is separated by means of thin spacer layers from another stack. The spacer layer may be 10 μm to 50 μm thick for example, and preferably made of Sylgard 184. The stacks may be adapted in such a way that the transmission of the first stack, that is the stack on the side from which the light enters the record carrier, is about 50% or higher and that the reflectivity of the second stack is about four times that of the first stack.

Also double sided record carriers which can be read from both sides can be obtained by employing the indirect heating method according to the present invention. Moreover, combinations of single sided double layer and double sided record carriers employing the indirect heating method are feasible.

According to a further embodiment of the present invention, a multi-level recording method can be employed with record carriers comprising AD/ADA or other recording stacks according to the present invention. By applying a multi-level recording write strategy marks of different size and depth may be written in the recording layer of the record carrier.

FIG. 9 illustrates a so called 10 T mark containing a pulse train of 9 write pulses with three embedded modulation levels. Thereby, different modulation levels correspond to different writing power of the writing laser beam. The mark was written beginning with three pulses at a low power level, continued with three pulses at a moderate power level and ending with three pulses at a high power level.

The resulting calculated mark shape generated at a recording speed of 10 m/sec in a record carrier according to the first embodiment of the present invention comprising a DA stack is depicted in FIG. 10. The direction along the track is shown horizontally, the width of the mark is shown vertically, starting from the center of the track at 0. The different contour lines denote the mark edge at different depths. Thereby, z=144 (small open circles) corresponds to marks written in the lower part of the dye layer near the adjacent absorption layer only and z=130 (big full circles) corresponds to marks written just beneath the upper surface of the dye layer opposite the absorption layer and closest to the substrate. As can be seen on the left of FIG. 10 the pulses at a low power level give rise to three partly overlapping dots within the mark being distinguishable at a depth not far away from the absorption layer (small open, small full, and medium-sized open circles). The pulses at a moderate level cause three dots being deeper and wider than those created by the low power writing pulses (small and medium-sized circles and big open circles). And finally, the dots written at a high power level on the right side of FIG. 10 reach the maximum depth all across the recording dye layer with a maximum width of more than 0.1 μm (all symbols).

In this way, the different depths of the mark give rise to different optical path lengths for a reflected reading beam. In addition, the widths of the mark lead to different modulations levels of the reflected reading beam. Thus, while reading marks written in the manner described above their different depth and width can be detected enabling a multi-level recording.

There are further writing strategies feasible. The mark length may not only be determined by a number of write pulses but by a single write pulse with different length, also. For example, an 8T mark may be written with one single long write pulse, with seven separated pulses (N−1 write strategy), or with four pulses (N/2 write strategy).

Different power levels within one sub-pulse train, meant for writing a single mark, may not only be applied to multi-level recording but additionally be adapted for avoiding heating up of the stack, also. For example, the writing power of the writing laser beam can be varied according to a predetermined write strategy depending on the thermal behavior of the employed recording stack while writing information on the optical record carrier.

It is noted that the present invention is not restricted to the above preferred embodiments. Other recording layer materials and/or absorption layer materials may be applied. Furthermore, the invention is not restricted to a write once record carrier and method. The writable record carrier may also be adapted for wavelength ranges other than those proposed above.

1. A writable optical record carrier comprising a substrate carrying a recording stack which recording stack comprises, in this order,
a recording layer and
formed on said recording layer opposite the substrate a first absorption layer, the recording layer being essentially transparent in its initial (unrecorded) state for an incident beam of electromagnetic radiation at a predetermined wavelength, and comprising material which changes its optical characteristics when it is heated,
the first absorption layer comprising material which has an absorption coefficient being sufficiently high at the predetermined wavelength to convert the incident beam to heat and thereby changing the optical characteristics of said recording layer material.

2. A record carrier according to claim 1, characterized in that said recording layer comprises organic dye material.

3. A record carrier according to claim 1 or 2, characterized in that said recording stack further comprises a second absorption layer located on the opposite side of said first absorption layer between said recording layer and said substrate.

4. A record carrier according to any of claims 1 to 3, characterized in that said first and second absorption layer material is a material with low thermal conductivity.

5. A record carrier according to claim 4, characterized in that said first and second absorption layer material is ZnS—SiO₂.

6. A record carrier according to any of claims 1 to 5, characterized in that said recording stack further comprises one or more additional layers adjacent to said first and/or second absorption layers in order to enhance the optical and thermal properties of the record carrier.

7. A record carrier according to any of claims 1 to 6, characterized in that said record carrier further comprises a cover layer attached to said recording stack located on the opposite side of said substrate.

8. A method for writing information on a writable optical record carrier,
the record carrier comprising a substrate carrying a recording stack which recording stack comprises, in this order,
a recording layer being essentially transparent in its initial (unrecorded) state for an incident beam of electromagnetic radiation at a predetermined wavelength and comprising material which changes its optical characteristics when it is heated, and
formed on said recording layer opposite the substrate a first absorption layer, in which method marks representing the information are written via a beam of electromagnetic radiation at a predetermined wavelength, the method comprising the following steps
positioning a writing unit at a predetermined position with respect to said record carrier,
generating said beam with a predetermined writing power by means of the writing unit,
transmitting said beam through said recording layer without changing the optical characteristics of said recording layer material
at least partially absorbing said beam in the first absorption layer, thereby producing a first spot of heat,
conducting the heat produced in the first absorption layer towards the recording layer, and
locally changing the optical characteristics of said recording layer material by means of the heat conducted from the heat spot in the first absorption layer.

9. A method according to claim 8, characterized in that
a second heat spot is produced by at least partially absorbing said beam in a second absorption layer located on the opposite side of said first absorption layer between said the recording layer and said substrate,
the heat produced in the second absorption layer is conducted towards the recording layer, and in that
the optical characteristics of the recording layer material are locally changed by means of the heat conducted from the heat spot in the first and the second absorption layers.

10. A method according to any of the claims 8 or 9, characterized in that the writing power of said beam is varied while writing information on said optical record carrier so that marks are written with different size and/or depth.

11. A method according to any of claims 8 to 10, characterized in that the writing power of said beam is varied for compensating heating up of the record carrier while writing information on said optical record carrier.
